(19) United States
(12) Patent Application Publication
(10) Pub. No.: US 2011/0066479 A1
(43) Pub. Date: Mar. 17, 2011

(54) SYSTEMS AND METHODS FOR CUSTOMER LOYALTY AND ADVERTISING

(75) Inventor: Todd R. Benson, Atlanta, GA (US)

(73) Assignee: ASSOCIATED DISCOUNT CLUBS OF AMERICA, LLC, BOUNTIFUL, UT (US)

(21) Appl. No.: 12/945,824

(22) Filed: Nov. 12, 2010

Related U.S. Application Data
(63) Continuation-in-part of application No. 12/151,783, filed on May 10, 2008.

(51) Int. Cl. G06Q 30/00; G06F 15/16

(52) U.S. Cl. 705/14.4; 709/217

(57) ABSTRACT

Systems, methods, apparatus, and computer program products are provided for improving the operation and relevance of customer loyalty programs through geo-location, affiliate marketing and targeted advertising.

### CROSS REFERENCE TO RELATED APPLICATIONS

This application is a continuation-in-part of U.S. application Serial No. 20090281883, filed May 10, 2008, which is hereby incorporated herein in its entirety by reference.

### BACKGROUND

The customer loyalty industry is comprised of various merchants, marketers and advertisers that devise means to attempt to attract and retain customers. However, existing approaches do not provide sufficiently effective functionality or services to attract interest and satisfy the needs of customers or merchants, resulting in diminished ability to maintain relevance and interest, likelihood of use, ability to understand and retain customers, maximize economy, generate value, and minimize waste in marketing and advertising.

### BRIEF SUMMARY

In general, embodiments of the present invention provide systems, methods, apparatus, and computer program products for customer loyalty programs and advertising, including geo-location, affiliate marketing and targeted advertising. In particular, programs can be enhanced with geo-location functionality enabling program participants to find other program participants, affiliate marketing techniques enabling programs to remunerate affiliates for enabling program activity and by targeted marketing enabling highly relevant advertising to program participants.

In accordance with one aspect, a system is provided for geo-location of program participants. In one embodiment, the system may include an enterprise system in electronic communication with a mobile electronic device, wherein the enterprise system includes one or more processors that may be configured to generate, transmit and receive program participant geo-location data, wherein the geo-location data includes unique identifiers identifying mobile program participants and their geo-location coordinates. In one embodiment, the enterprise system may be configured to generate an electronic message, which includes at least a portion of (a) the program participant's geo-location data, (b) the program participant's program participant data contained within the system corresponding with the geo-location of nearby program participants, (c) program participant data of other program participants corresponding with the geo-location of the program participant, and (d) advertising for program participants enabled for delivery via the enterprise system. Moreover, the enterprise system includes one or more processors that may be configured to: (1) electronically transmit, from the enterprise system to a remote computing device for display, an electronic message that comprises at least a portion of the program participant's geo-location data and program participant data and advertising enabled for delivery via the program system; (2) after transmitting the electronic message to the remote computing device for display, receive, via the enterprise system, transmitted from the remote computing device, an initiation of a location event for the program participant, wherein the location event indicates (a) the geo-location of the program participant and (b) an electronic message containing at least a portion of information displayed on the remote computing device; when: (1) a command is executed or when a predefined threshold is met; (2) a program participant effects a request after the remote computing device (a) causes display of an advertisement, (b) provides access to a website, (c) effects purchase from a program participant, (d) determines a predefined threshold is met, (e) enables a program participant to enter geo-location information into the remote computing device, or (f) effects a log-in protocol; (3) a program participant effects a request that (a) causes display of an advertisement, (b) provides access to a website, (c) effects purchase from a program participant, (d) effects a sale to a program participant, (e) enters geo-location information into the remote computing device, or (f) effects a log-in protocol.

In accordance with another aspect, a system is provided for geo-location of program participants. In one embodiment, the system may include an enterprise system in electronic communication with a mobile electronic device, wherein the enterprise system includes one or more processors that may be configured to deliver to a remote computing device a program software application to enable the remote computing device to generate, transmit and receive from the enterprise system program participant geo-location data when a program participant executes a request to receive an application in response to a remote computing device.

In accordance with another aspect, a computer implemented method for tracking the geo-location of program participants and correlating with the geo-location of other program participants is provided. In one embodiment, the method may comprise receiving, via an enterprise system, data associated with a program participant, wherein the data comprises a unique identifier assigned to the program participant and information corresponding to the program participant's geo-location; generating, via the enterprise system, an electronic message, wherein the electronic message comprises at least a portion of (a) the program participant's geo-location data, (b) the program participant's program participant data contained within the system corresponding to the geo-location of nearby program participants, (c) program participant data of other program participants corresponding with the geo-location of the program participant, and (d) advertising for program participants enabled for delivery via the enterprise system; electronically transmitting, from the enterprise system to a remote computing device for display, an electronic message that comprises at least a portion of the program participant's geo-location data and program participant data and advertising enabled for delivery via the program system; after transmitting the electronic message to the remote computing device for display, receiving, via the enterprise system, transmitted from the remote computing device, an initiation of a location event for the program participant, wherein the location event indicates (a) the geo-location of the program participant and (b) an electronic message containing at least a portion of information displayed on the remote computing device.

In accordance with another aspect, a computer program product is provided, which in one embodiment enables delivery by an enterprise system to a remote computing device of a program software application to enable the remote computing device to generate, transmit and receive from the enterprise system program participant geo-location data, the computer program product comprising at least one computer-readable storage medium having computer-readable program code portions stored therein, the computer-readable program code portions comprising: (1) an executable portion configured to generate a program software application for delivery to a remote computing device when a program participant executes a request to receive an application in response to a remote computing device and, (2) an executable portion configured to transmit from an enterprise system to a remote computing when a program participant executes a request in response to a remote computing device.

In accordance with yet another aspect, a computer program product is provided, which in one embodiment enables receipt by an enterprise system of program participant geo-location data generated by a remote computing device and transmission of program participant geo-location data to a remote computing device, the computer program product comprising at least one computer-readable storage medium having computer-readable program code portions stored therein, the computer-readable program code portions comprising: (1) an executable portion configured to receive a first message transmitted from a remote computing device when a command is executed or when a predefined threshold is met; (2) an executable portion configured to receive a message automatically transmitted when a program participant effects a request after the remote computing device (a) causes display of an advertisement, (b) provides access to a website, (c) effects purchase from a program participant, (d) determines a predefined threshold is met, (e) enables a program participant to enter geo-location information into the remote computing device, or (f) effects a log-in protocol; (3) an executable portion configured to receive a message automatically transmitted when a program participant effects a request that (a) causes display of an advertisement, (b) provides access to a website, (c) effects purchase from a program participant, (d) effects a sale to a program participant, (e) enters geo-location information into the remote computing device, or (f) effects a log-in protocol.

In accordance with one aspect, a system is provided for attributing and qualifying program activity for the payment of commission to affiliates to enable affiliate marketing in a program. In one embodiment, the enterprise system may include an enterprise system in communication with a remote electronic device, wherein the enterprise system includes one or more processors that may be configured to generate, transmit, receive and store program affiliate links, affiliate identification, program participant identification, program participant affiliate identification, affiliate data, attribution data, qualification data and affiliate commission data, wherein program affiliate link and the affiliate data, attribution data, qualification data and commission data include unique identifiers identifying affiliates and program participants. Moreover, the one or more processors or the enterprise system may be configured to: generate an electronic message, which includes at least a portion of the (a) affiliate data, (b) program participant data, (c) program participant program activity data, (d) a determination by the enterprise system whether the program activity is qualified for inclusion in commission calculation, (e) a determination by the enterprise system whether an affiliate is entitled to a commission for program participant's program activity and (f) amount of commission to which affiliate is entitled. Additionally, the one or more processors of the enterprise system may also be configured to: (1) attribute to affiliates program activity recorded in electronic messages received, generated and transmitted containing program activity data by an enterprise system and to generate program participant affiliate data; (2) determine whether program activity recorded in electronic messages received, generated or transmitted qualifies for commission by (a) comparing program participant affiliate data for such program activity with program participant affiliate data previously stored and program qualification requirements thresholds and (b) qualifying only program activity meeting program requirements, meeting, exceeding or not exceeding system thresholds or where a program requirement for program participants not previously identified as affiliated with the same or another affiliate; (3) generate, transmit, receive and store qualification data; and (4) (a) associate qualification data with affiliates, (b) determine when commission due an affiliate meets or exceeds a program threshold for initiation of a commission event, (c) when program threshold for initiation of a commission event is exceeded, calculate a commission amount, (d) generate an electronic message containing commission data, (e) effect affiliate commission payment.

In accordance with yet another aspect, a computer-implemented method for attributing and qualifying program activity for the payment of commission to affiliates to enable affiliate marketing in a program is provided. In one embodiment the method comprises: (1) receiving, via an enterprise system, data associated with an affiliate, wherein the data comprises a unique identifier assigned to the affiliate and information corresponding to the affiliate; (2) generating, via an enterprise system, a program affiliate link that can be used by an affiliate on a remote computing device for affiliate marketing purposes to associate with the affiliate parties clicking through the link to a program website; (3) receiving, via an enterprise system, data associated with a program participant, wherein the data comprises (a) program participant identification (b) information corresponding to the program participant and (c) a program participant affiliate identification associated with such program participant when such program participant clicked through a program affiliate link; (4) generating, via an enterprise system, a program participant affiliate identification, wherein the data comprises (a) a program participant identification and (b) an affiliate identification; generating, via an enterprise system, data associating an affiliate with a program participant and a program participant's program activity for (a) qualifying and attribution purposes and (b) determination whether the program participant has previously been identified with the affiliate or another affiliate and program activity; (5) generating, via an enterprise system, an electronic message, wherein the electronic message comprises at least a portion of the (a) affiliate data, (b) program participant data, (c) program participant program activity data, (d) a determination by the enterprise system whether the program activity is qualified for inclusion in commission calculation, (e) a determination by the enterprise system whether an affiliate is entitled to a commission for program participant's program activity and (f) amount of commission to which affiliate is entitled; and generating, via the enterprise system, (6) an initiation of a commission event for the affiliate, wherein the commission event (a) indicates the affiliate identification, (b) initiates an electronic message containing at least a portion of information displayed on the remote computing device relating to qualified program activity and the amount of commission to be paid to the affiliate, (c) initiates payment of the commission to the affiliate.

In accordance with yet another aspect, a computer program product is provided, which in one embodiment enables attribution and qualification of program activity, generation of affiliate commission data enabling payment of affiliate commissions and receipt, generation and storage by an enterprise system of affiliate data, the computer program product comprising at least one computer-readable storage medium having computer-readable program code portions stored therein, the computer-readable program code portions comprising: (1) an executable portion configured to attribute to affiliates program activity recorded in electronic messages received, generated and transmitted containing program activity data by an enterprise system and to generate program participant affiliate data; (2) an executable portion configured to determine whether program activity recorded in electronic messages received, generated or transmitted qualifies for commission by (a) comparing program participant affiliate data for such program activity with program participant affiliate data previously stored and program qualification requirements thresholds and (b) qualifying only program activity meeting program requirements, meeting, exceeding or not exceeding system thresholds or where a program requirement for program participants not previously identified as affiliated with the same or another affiliate; (3) an executable portion configured to generate, transmit, receive and store qualification data; and (4) an executable portion configured to (a) associate qualification data with affiliates, (b) determine when commission due an affiliate meets or exceeds a program threshold for initiation of a commission event, (c) when program threshold for initiation of a commission event exceeded, calculate a commission amount, (d) generate an electronic message containing commission data, (e) effect affiliate commission payment.

In accordance with yet another aspect, a system is provided for implementing targeted advertising in a program. In one embodiment, the enterprise system may include an enterprise system in communication with a remote electronic device, wherein the enterprise system includes one or more processors that may be configured to generate, transmit, receive and store program activity and external data relating to program participants, program participant advertising relevance data, advertising metadata and targeted advertising. Moreover, the one or more processors of the enterprise system may be configured to: generate an electronic message, which includes at least a portion of the (a) program activity and external data relating to program participants, (b) program participant advertising relevance data, (c) advertising data and (d) targeted advertising. Additionally, the one or more processors of the enterprise system may also be configured to: (1) receive, track and store program activity recorded in electronic messages containing program activity data received, generated and transmitted by the enterprise system; (2) determine the advertising relevance of an advertisement by comparing program participant data with advertising metadata; (3) monitor program participant program activity; (4) determine the priority of relevant advertising for exposure to a program participant; (5) retrieve a matching advertisement; and, (6) determine the effectiveness of advertising provided to a program participant.

In accordance with yet another aspect, a method for implementing targeted advertising in a program is provided. In one embodiment the method comprises: (1) receiving, via an enterprise system, data associated with a program participant, wherein the data comprises program participant data; (2) storing, via the enterprise system, the program participant data; (3) receiving, via the enterprise system, metadata tags describing the content of advertisements to be delivered; (4) determining, via the enterprise system, which advertisements match program participant data; (5) retrieving, via the enterprise system, the advertisements determined to match program participants; and, (6) delivering, via the enterprise system, the advertisements determined to match program participant data. In another embodiment the method comprises: (1) receiving, via an enterprise system, data associated with a program participant, wherein the data comprises program participant data; (2) storing, via the enterprise system, the program participant data; (3) transmitting, via the enterprise system, the program participant data or metadata tags from a program participant advertising relevance profile describing the program participant; (4) receiving bids from potential advertisers wishing to provide targeted advertising to the program participant; (5) determining, via the enterprise system, which advertisements match program participant data and most exceed program prioritization criteria; (6) retrieving, via the enterprise system, advertisements selected for the program participant; and, (7) delivering, via the enterprise system, advertisements selected for the program participant.

In accordance with yet another aspect, a computer program product is provided, which in one embodiment enables tracking and storing of program activity and external data relating to program participants, generation and storing of program participant advertising relevance data in a program participant advertising relevance profile, comparison of program participant data or program participant advertising relevance data with advertising metadata for purposes of determining advertising relevance, selecting and delivering targeted advertising, determining advertising effectiveness and updating the program participant advertising relevance profile, the computer program product comprising at least one computer-readable storage medium having computer-readable program code portions stored therein, the computer-readable program code portions comprising: (1) an executable portion configured to receive, track and store program activity recorded in electronic messages containing program activity data received, generated and transmitted by an enterprise system; (2) an executable portion configured to determine the advertising relevance of an advertisement by comparing program participant data with advertising metadata; (3) an executable portion configured to monitor program participant program activity; (4) an executable portion configured to determine the priority of relevant advertising for exposure to a program participant; (5) an executable portion configured to retrieve a matching advertisement; and (6) an executable portion configured to determine the effectiveness of advertising provided to a program participant.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of one embodiment of a system that can be used to practice various aspects of the present invention.

FIG. 2 shows an enterprise system according to one embodiment of the present invention.

FIG. 3 shows a supervisory computing device according to one embodiment of the present invention.

FIG. 4 shows a mobile electronic device according to one embodiment of the present invention.

FIGS. 5-12 are flowcharts illustrating operations and processes that can be used in accordance with various embodiments of the present invention.

FIGS. 13-14 show exemplary input/output according to one embodiment of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely software embodiment, an embodiment in which a processor is programmed to perform certain steps or an embodiment combining software and hardware aspects. Furthermore, various implementations may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a general purpose computer, a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. General Overview

In general, according to various embodiments of the present invention, methods, apparatus, systems, and computer program products are provided for added and enhanced capabilities and functionalities in customer loyalty programs. In general, the term “system” may refer to, for example, any computer, computing device, mobile phone, desktop, notebook or laptop, distributed system, server, blade, gateway, switch, processing device, or combination of processing devices adapted to perform the functions described herein. The term “application” may be used generically herein to refer to a computer program designed to perform a specific function directly for a user or for another computer program at the request of a user or another computer program. The term “request” may be used generically herein to refer to a specific order or program system command to perform a service or action. This may be accomplished via a remote computing device, graphical user interface, an enterprise system, link or an application. The term “customer loyalty program” may be used generically to refer to a single or multiple merchant customer loyalty program designed to provide membership and incentives to attract and retain customers. The term “program” may be used even more generically herein to refer to a customer loyalty program and systems, methods or computer program products designed to attract and retain consumers. The term “member” may be used generically herein refer to a person, group or entity provided membership in a program. The term “merchant” may be used generically herein to refer to any individual, group or entity offering products or services for sale. The term “program participant” may be used generically herein to refer to a member or merchant participating in a program. The term “program provider” may be used generically herein to refer to any person, entity or group or creating, providing, enabling or supporting a program. The term “program participant data” may be used generically herein to refer to data relating to a program participant such as a member or merchant, such as system preferences, profile data and program activity data relating to the activity of a program participant in a program system. The term “program activity” may be used generically herein to refer to activity by a program participant in a program such as information tracked by an enterprise system relating to purchases by a member, geo-location data, advertising response or web navigation. The term “program activity data” as used generically herein may have reference to information relating to program activity.

### General System Architecture

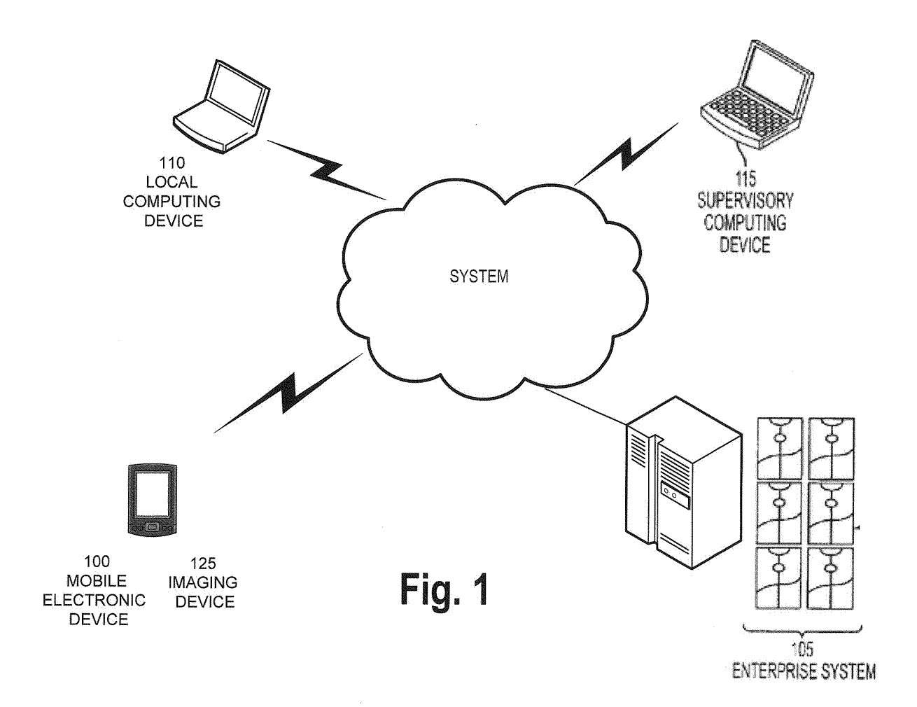

FIG. 1 provides an illustration of one type of system that can be used in conjunction with various embodiments of the present invention. As shown in FIG. 1, the system may include a mobile or handheld electronic device 100 (“mobile”), an enterprise system 105, a local computing device 110, and a supervisory computing device 115. Each of these components of the system may be in electronic communication with one another, a member, a merchant or other program participant (e.g., with the aid of a personal computer (“PC”), laptop, or similar electronic device) over the same or different wireless or wired networks including, for example, a wired or wireless Personal Area Network (“PAN”), Local Area Network (“LAN”), Metropolitan Area Network (“MAN”), Wide Area Network (“WAN”), and/or the like. In general, the term “computing device” is used generically throughout to refer to any computer, mainframe, desktop, notebook or laptop, distributed system, server, gateway, switch, or other processing device configured to perform the functions described herein. Additionally, while FIG. 1 illustrates the enterprise system 105, local computing device 110, and the supervisory computing device 115 as separate, standalone entities, one of ordinary skill in the art will recognize that the various embodiments herein are not limited to this particular architecture. For example, the functionality of the enterprise system 105, the local computing device 110, and the supervisory computing device 115 may each occur on a single server, a mainframe computer system, multiple distributed or centralized servers, or similar computer systems or network entities.

The system may also include an imaging device(s) 125. The imaging device 125 may be any analog or digital camera for capturing images of items, such as images of products or bar codes for products and/or other items to search for such items for sale from a program participant or to input advertisements into an enterprise system. The imaging device 125 may, for example be mounted as the digital camera of a program participant's mobile electronic device 100. In one embodiment, the imaging device 125 captures digital images that can be electronically stored and communicated to various computing entities. And although not shown, the imaging device 125 may also be in electronic communication with the handheld electronic device 100, the enterprise system 105, the local computing device 110, and the supervisory computing device 115 via the same or different wired or wireless networks.

### Enterprise System

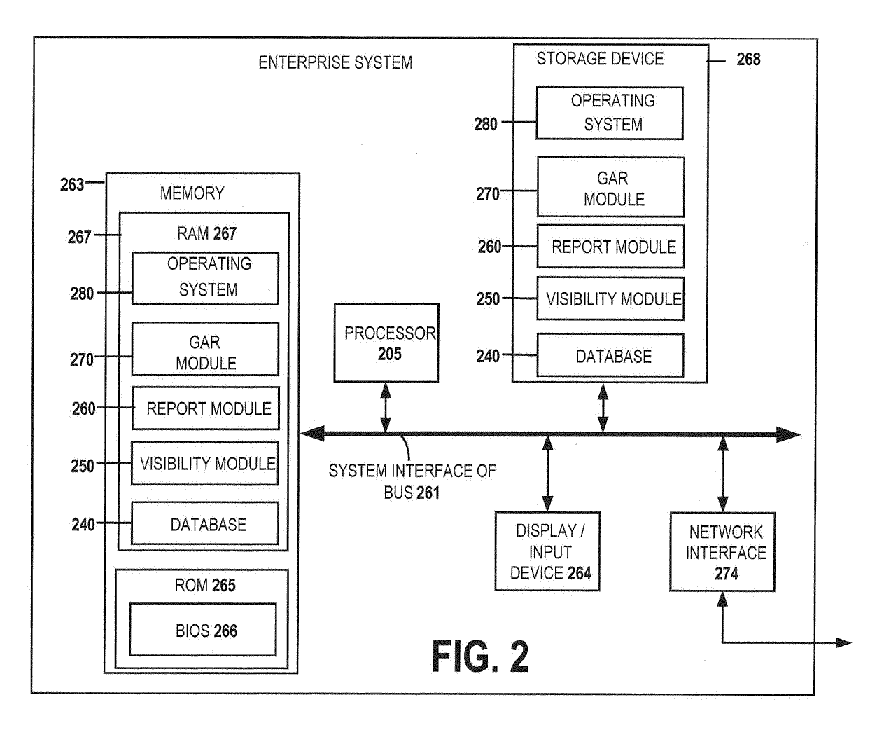

FIG. 2 provides a schematic of an enterprise system 105 according to one embodiment of the present invention. As will be understood from this figure, in this embodiment, the enterprise system 105 may include a processor 205 that communicates with other elements within the enterprise system 105 via a system interface or bus 261. The processor 205 may be embodied in a number of different ways. For example, the processor 205 may be embodied as a processing element, a coprocessor, a controller or various other processing devices including integrated circuits such as, for example, an application specific integrated circuit (“ASIC”), a field programmable gate array (“FPGA”), a hardware accelerator, or the like. In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention while configured accordingly.

A display device/input device 264 for receiving a displaying data may also be included in the enterprise system 105. This display device/input device 264 may be, for example, a keyboard or pointing device that is used in combination with a monitor. The enterprise system 105 may further include memory 263, which may include both read only memory (“ROM”) 265 and random access memory (“RAM”) 267. The server's ROM 265 may be used to store a basic input/output system (BIOS) 266 containing the basic routines that help to transfer information to the different elements within the enterprise system 105.

In addition, in one embodiment, the enterprise system 105 may include at least one storage device 268, such as a hard disk drive, a CD drive, and/or optical disk drive, embedded or removable multimedia memory cards (“MMCs”), secure digital (“SD”) memory cards, Memory Sticks, electrically erasable programmable read-only memory (“EEPROM”), flash memory, hard disk, or the like for storing information on various computer-readable media. The storage device(s) 268 and its associated computer-readable media may provide nonvolatile storage. The computer-readable media described above could be replaced any other type of computer-readable media, for example, magnetic cassettes, flash memory cards, and digital video disks. As will be appreciated by one of ordinary skill in the art, each of these storage devices 268 may be connected to the system bus 261 by an appropriate interface.

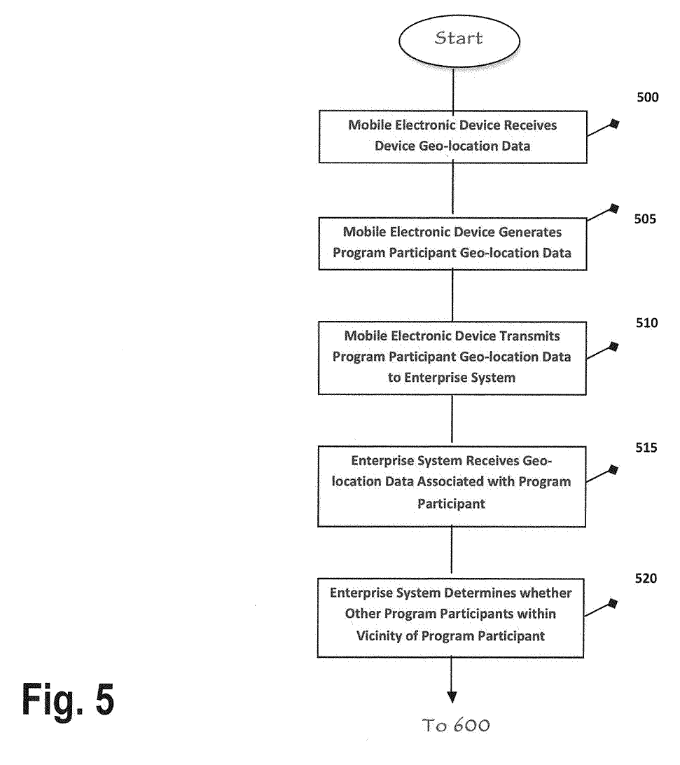

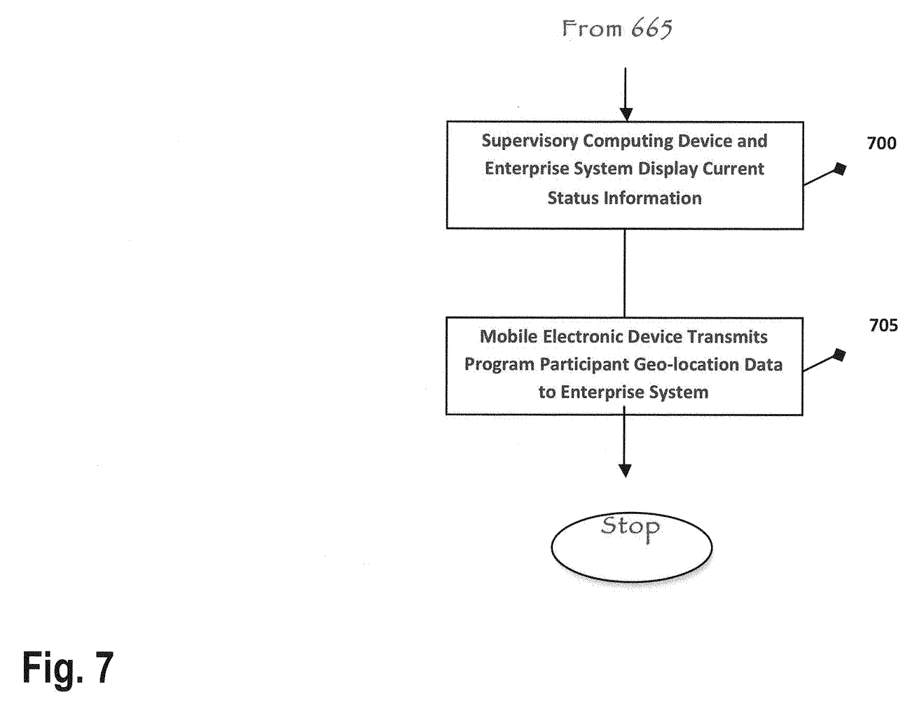

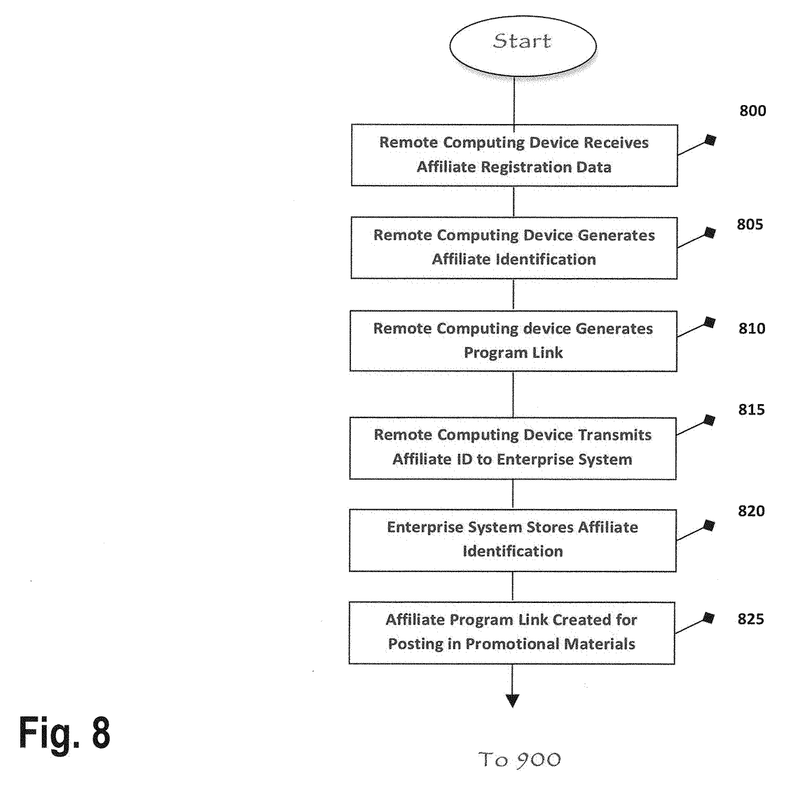

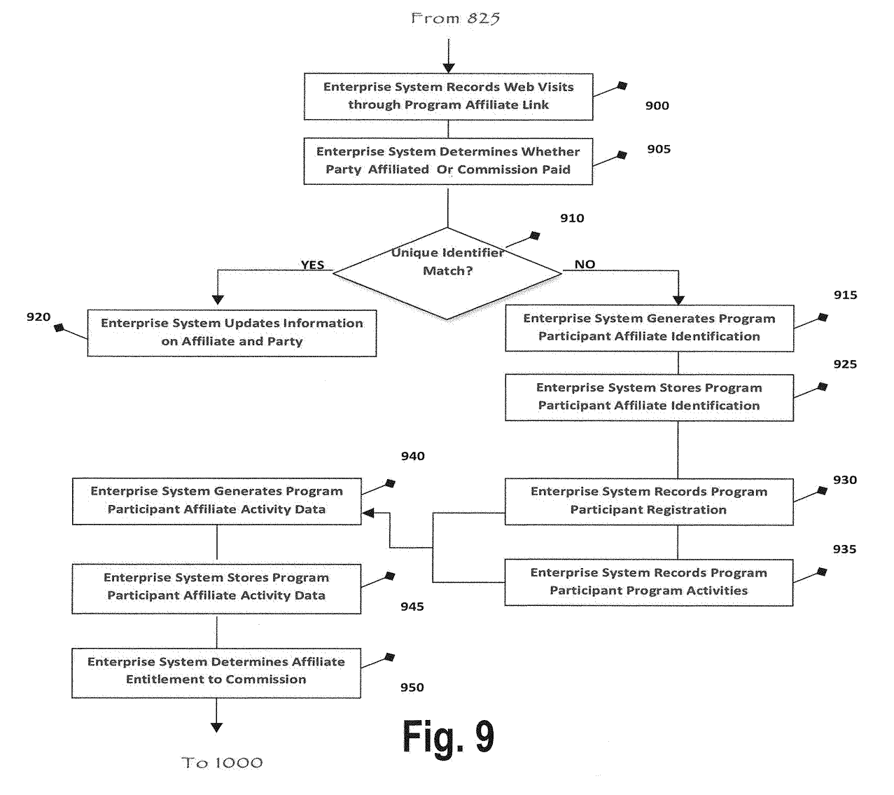

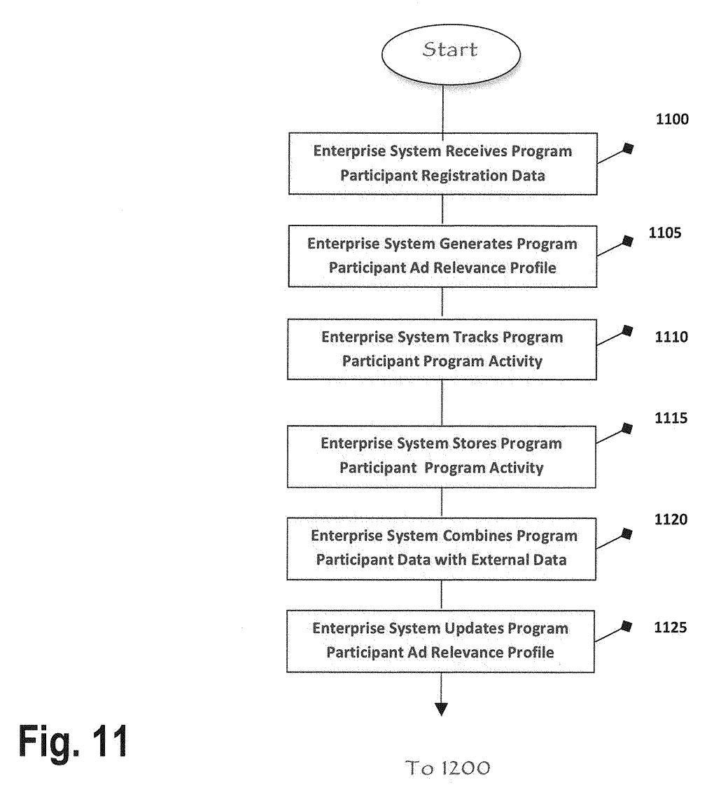

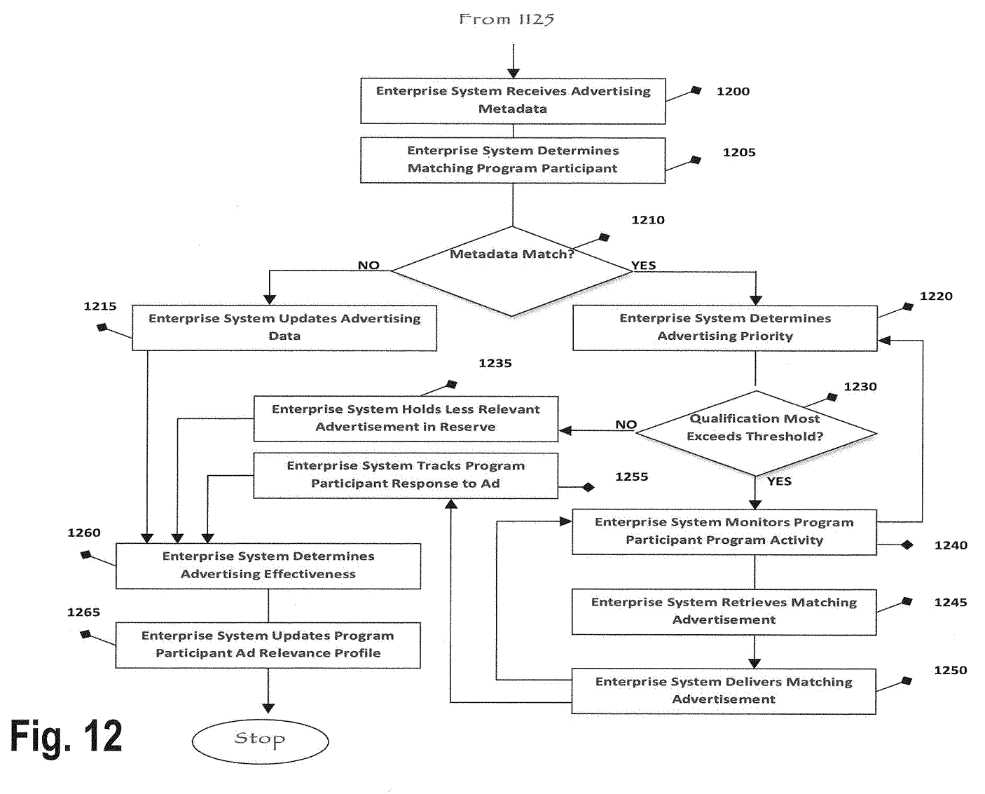

Furthermore, a number of program modules may be stored by the various storage devices 268 and/or within RAM 267. Such program modules may include an operating system 280, a geo-location, affiliate marketing, relevant advertising (“GAR”) module 270, a report module 260, a visibility module 250, and a database module 240. These modules may control certain aspects of the operation of the enterprise system 105 with the assistance of the processor 205 and the operating system 280—although their functionality need not be modularized. For example, as discussed in more detail below with regard to FIGS. 5-7, according to one embodiment, the GAR module 270 may determine the geo-location of program participants near a mobile member (e.g., street addresses of merchants within a defined radius of such member). In another embodiment, as discussed in more detail below with regard to FIGS. 8-10, the GAR module 270 may enable affiliate marketing for a program. In yet another embodiment, as discussed in more detail below with regard to FIGS. 11-12, the GAR module 270 may enable program targeted advertising. Additionally, according to one embodiment, the visibility module 350 can provide real-time visibility to the movement of program participants in a defined geographic area, affiliate marketing status and advertising delivery status. And the report module 260 in one embodiment may generate reports relating to movements of members relative to other program participants, affiliate marketing and advertising delivery. In addition to the program modules, the enterprise system 105 may store one or more databases (not shown) with one or more tables therein. As will be recognized, the described architectures are provided for illustrative purposes only and are not limiting to the various embodiments. In this regard, although various program modules are described, the software need not be modularized or if modularized the functions of the modules described, such as the GAR module 270, may be treated in single or multiple modules.

Also located within the enterprise system 105 may be a network interface 274 for interfacing with various computing entities such as the mobile 100, the local computing device 110, the supervisory computing device 115 and the imaging device 125. This communication may be via the same or different wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the enterprise system 105 may be configured to communicate via wireless external communication networks using any of a variety of protocols, such as 802.11, general packet radio service (“GPRS”), wideband code division multiple access (“W-CDMA”), or any other wireless protocol. Via the network interface 274, the enterprise system 105 may be capable of sending and receiving text messages and/or instant messages.

It will be appreciated that one or more of the enterprise system's 105 components may be located remotely from other enterprise system 105 components. Furthermore, one or more of the components may be combined and additional components performing functions described herein may be included in the enterprise system 105.

Additional computing devices described herein may each include one or more components that are functionally similar to those of the enterprise system 105. For example, in one embodiment, each such computing device may include: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments.

### Supervisory Computing Device

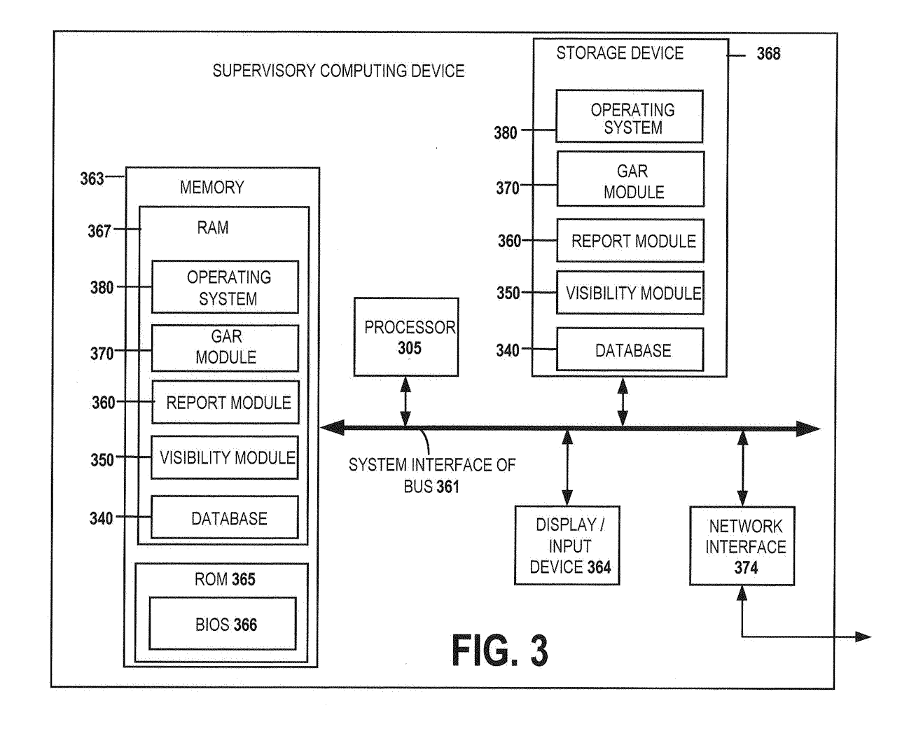

FIG. 3 shows a schematic diagram of a supervisory computing device 115 according to one embodiment of the invention. Similar to the enterprise system 105, the supervisory computing device 115 may include: (1) a processor 305 that communicates with other elements within the supervisory computing device 115 via a system interface or bus 361; (2) a display device/input device 364; (3) memory 366 including both ROM 365 and RAM 367; (4) a storage device 368; and (5) a network interface 374. The ROM 365 may store a BIOS 366, while the storage device 368 and/or RAM 367 may store a BIOS 366, while the storage device 368 and/or RAM 367 may store an operating system 380, a geo-location, affiliate marketing, relevant advertising (GAR) module 370, a report module 360, a visibility module 350 for controlling certain aspects of the supervisory computing device 115 with the assistance of the processor 305 and a database 340. For instance, the visibility module 350 may provide real-time visibility to the movement of program participants in a defined geographic area, program activity and advertising delivery. As will be appreciated by one of ordinary skill in the art, one or more of the supervisory computing device 115 components may be located geographically remotely from the other supervisory computing device 115 components. Furthermore, one or more of the components of the supervisory computing device 115 may be combined within the enterprise system 105 or distributed via other systems or computing devices to perform the functions described herein. That is, the described architectures are provided for exemplary purposes only and are not limiting to the various embodiments. Thus, although various program modules are described, the software need not be modularized.

### Mobile Electronic Device

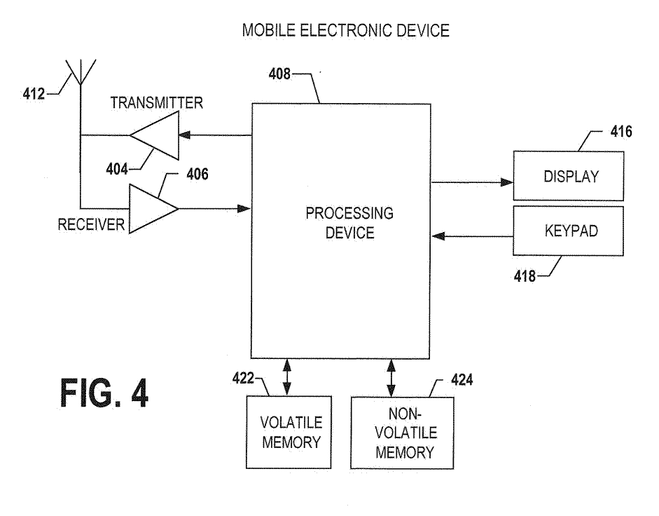

FIG. 4 is an illustrative schematic representative of a mobile 100 that can be used in conjunction with various embodiments of the present invention. The term “mobile” is used generically throughout to refer to any handheld or mobile electronic device, such as a pocket PC, personal digital assistant (“PDA”), handheld computer, smartphone, portable media player, camera, laptop, pager, converged device, handheld game console, personal navigation device, and the like—including both wireless and wireline devices. As shown in FIG. 4, the mobile 100 may include an antenna 412, a transmitter 404, a receiver 406, and means, such as a processing device 408, e.g., a processor, controller, or the like, that provides signals to and receives signals from the transmitter 404 and receiver 406, respectively. The signals provided to and received from the transmitter 404 and the receiver 406, respectively, may include signaling information in accordance with an air interface standard of applicable wireless systems. In this regard, the mobile 100 may operate in accordance with any of a number of second-generation (“2G”) communication protocols, third-generation (“3G”) communication protocols, and/or the like. Further, for example, the mobile 100 may operate in accordance with any of a number of differing wireless networking techniques, including Bluetooth, 802.11 (“Wi-Fi”), 802.16 (“WiMAX”), ultra wideband (“UWB”), and/or the like. Like these communication standards and protocols, the mobile 100 can communicate with the various entities show in FIGS. 1 and 5(H). The mobile 100 can also download changes, add-ons, and updates, for instance, to its firmware, software (e.g., including modules), and operating system.

The mobile 100 may also comprise a user interface (that can include a display 416 coupled to a processing device 408) and/or a user input interface (coupled to the processing device 408). The user input interface can comprise any of a number of devices allowing the mobile 100 to receive data, such as a keypad 418, a touch display (not shown), barcode reader (not shown) or other input device. In embodiments including a keypad 418, the keypad 418 can include the conventional numeric (0-9) and related keys (#, *), and other keys used for operating the mobile 100 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Although not shown, the mobile 100 may also include a battery, such as a vibrating battery pack, for powering the various circuits that are required to operate the handheld 100, as well as optionally providing mechanical vibration as a detectable output.

The mobile 100 can also include volatile memory 422 and/or non-volatile memory 424, which can be embedded and/or may be removable. For example, the non-volatile memory may be embedded or removable multimedia memory cards (“MMCs”), secure digital (“SD”) memory cards, Memory Sticks, EEPROM, flash memory, hard disk, or the like. The memory can store any of a number of pieces or amount of information and data used by the mobile 100. For example, the volatile and non-volatile memory can be used to temporarily or permanently store input from the computing device and/or input entered by the user via the user input interface. The memory can also store content, such as computer program code for an application and/or other computer programs.

### III. General System Operation

### A. Program Participant Geo-Location

A system according to a particular embodiment may include the mobile electronic device 100, the enterprise system 105, the local computing device 110 and a supervisory computing device 115 to provide for geo-location of program participants. For example, a program participant may request a geo-location application to be downloaded onto the program participant's mobile electronic device 100. The mobile electronic device 100 may then request and receive information about the geo-location of a program participant (e.g., when a member logs in to the member's mobile electronic device 100 and/or when a program participant moves from one geographic location to another). A unique identifier (e.g., a message identifying the member) may then be associated to the information. As will be appreciated, the term “geo-location” may have reference to the detection via wireless or otherwise via any technology used separately or in combination such as Internet Protocol (IP) address, Wi-Fi connection location, Direction Finding with reference to line of bearing to a transmitter, Time Difference of Arrival (TDOA) utilizing mapping displays or other graphical information, Global Positioning System (GPS) coordinates, phone number and/or International Mobile Equipment Identity (IMEI) number, a unique 17 or 15 digit code used to identify an individual Global System for Mobile Communications (GSM), Wideband Code Division Multiple Access (WCDMA), Universal Motile Telecommunications System (UMTS) and Integrated Digital Enhanced Network (iDEN) mobile phones as well as some satellite phones and self-disclosed address coordinates of the physical real-world geographic location (e.g., country, region, city, postal code/zip code, latitude, longitude, time zone, street address) of a program participant with reference to Internet Protocol (IP) address, Media Access Control (MAC) address, Radio Frequency Identification (RFID), hardware embedded article/production number, embedded software number (e.g., Universally Unique Identifier (UUID), Exchangeable Image File format (Exif)/International Press Telecommunications Council (IPTC)/Extensible Metadata Platform (XMP) or modern steganography), invoice, Wi-Fi connection location, with specific emphasis on correlating position with street address.

The enterprise system 105 can use the information provided by the mobile electronic device 100 to identify the geo-location of other program participants within defined geographic areas around the member. After the geo-location of other program participants is determined, the enterprise system 105 may generate an electronic message, which may include the member's geo-location coordinates, the geo-location coordinates of other program participants within defined geographic areas around the member, information about such program participants and directions, such as identification on a map, about how to locate such program participants. The enterprise system 105 may then transmit the electronic message to the local computing device 110 and/or the supervisory computing device 115. Either or both of these devices and/or the enterprise system 105 can be used to transmit the electronic message to the mobile electronic device 100.

Once the electronic message has been transmitted to the mobile electronic device 100, the mobile electronic device 100 may cause display of the electronic message or at least a portion thereof via a display. At this point, the member can select a program participant the member wishes to locate. With the geo-location of program participants identified for display, the program participants, their geo-location coordinates and directions to find them can be identified and viewed.

In the update process, according to one embodiment, the mobile electronic device 100 may track the member's movements and send data on the member's movements to the enterprise system 105. As updated information is received, the enterprise system 105 can send updated electronic messages such as above described. Otherwise, the enterprise system 105 may generate an updated electronic message and transmit the message to the mobile electronic device 100. Thus, in one embodiment, the enterprise system 105 may update the electronic message to reflect the geo-location of program participants within a defined radius of member's new location.

During the entire geo-location process, the mobile electronic device 100 may also receive data about member movements, the program participants selected by member for geo-location, and/or the like. The mobile electronic device 100 may even provide the above-described information to the enterprise system 105 and/or the local computing device 110 and/or the supervisory computing device 115 as it is received. This information can then be used to generate reports and provide real-time visibility of the information to the program provider and/or other program participants.

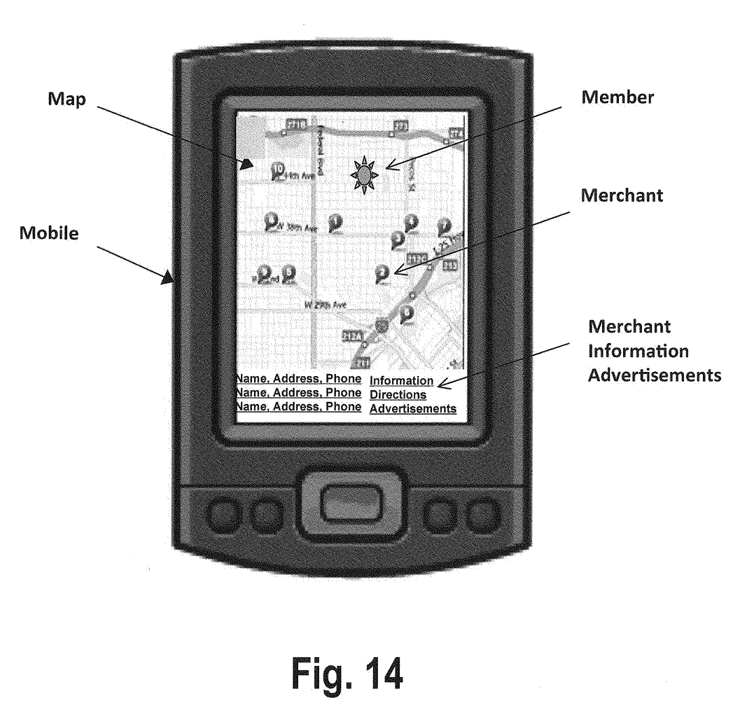

Reference will now be made to FIGS. 5-7, which provide an example of operations and input and output produced by various embodiments of the present invention. In particular, FIG. 5 provides a flowchart illustrating operations that may be performed to provide a mobile or stationary program participant with the geo-location of other program participants within a defined geographic area, for example the street address of merchants within a 10-mile geographic radius of a the member's current geo-location. Some of these operations will be described in conjunction with FIG. 14, which illustrates output that may be produced by carrying out the selected operations in FIGS. 5-7. The terms “geo-location data” and “program participant geo-location data” are used generically to refer to data that refers to the geo-location of computing devices such as mobiles and program participants, respectively.

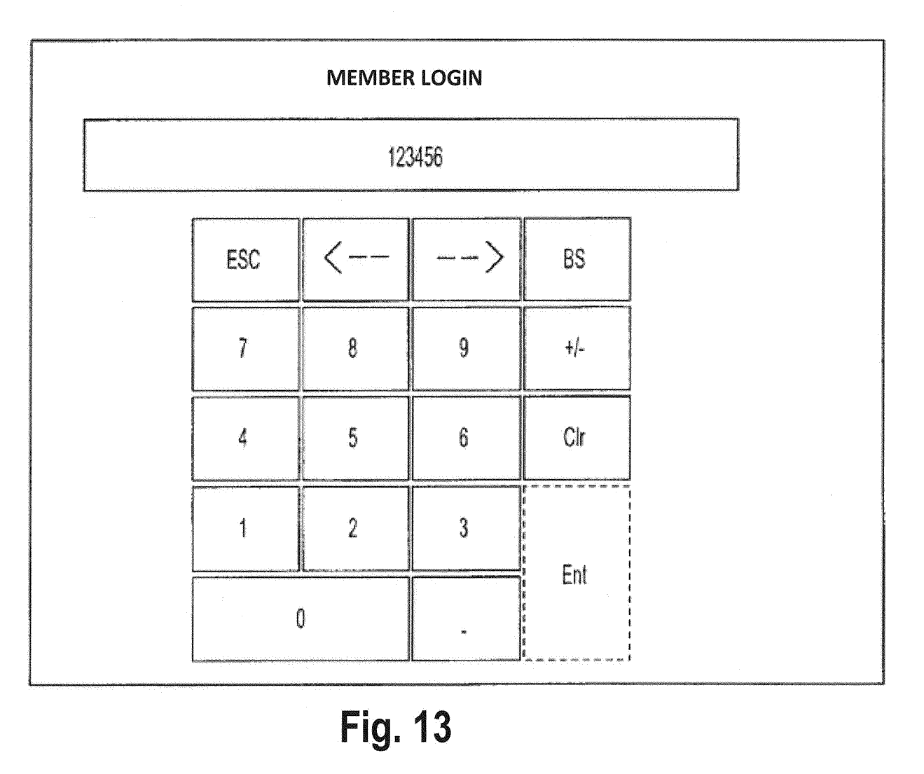

Geo-location functionality may be enabled by a member request to download a program application provided via the enterprise system 105 that operates on the mobile 100 (not illustrated). Before the process begins, in one embodiment, the mobile may receive a member's login (not illustrated). The member login may be received before, during, or after turning on program functionality available through a program application on a member's mobile, pursuant to which a member holding a mobile 100 may log-in to the member's mobile 100 and enable geo-location functionality. Alternatively, a program application may automatically cause the mobile 100 to transmit the member's program participant geo-location data to the enterprise system 105 when the member turns on the mobile 100 (not illustrated). After the member's identity has been verified, the mobile can display the electronic message or at least a portion thereof (not illustrated). An illustrative member login screen displayed on a mobile 100 is shown in FIG. 13. In another embodiment, a member holding a mobile 100 may initiate geo-location functionality by moving from one place to another. For example, a member may go shopping and drive from one location to another. As the member shops, the member may use the member's mobile 100 to view merchant locations in the vicinity. The enterprise system 105 may automatically update merchant locations in the member's vicinity viewable in the member's mobile 100 as the member moves. Alternatively, the member may enter geo-location coordinates into the mobile 100 for identification of program participants in the vicinity of such coordinates.

After the mobile 100 receives data relating to the geo-location of the device, “device geo-location data” (Block 500), the mobile 100 may generate data correlating the device geo-location data with the identity of the program participant, together in combination “program participant geo-location data” (Block 505). For example, the mobile 100 may associate the unique identifier of a member with device geo-location data as the member moves from one geographical location to another resulting in the creation of program participant geo-location data at various points as the member moves. Illustratively, if a member were driving in a car from Los Angeles to Orlando, the mobile 100 may associate the member's unique identifier with device geo-location data at multiple points along the way and transmit such data to the enterprise system 105 (Block 510).

At each point where program participant geo-location data is created, the enterprise system 105 can receive the program participant geo-location data and determine whether other program participants are located within a parameter defined by reference to the program participant's geo-location. For example, the enterprise system 105 can determine whether there are any program participants within a two-mile radius of a member's current geo-location (Blocks 515 to 630). In one embodiment, the geo-location module 270 receives program participant geo-location data and makes the determination. Illustratively, if a member were driving in a car from Orlando to New York, the geo-location module 270 would receive program participant geo-location data at various times reflecting the geographical movement of the member; the geo-location module would compare the geo-location coordinates of the member with the geo-location coordinates of merchants to determine the respective geographical positions of the program participants; the geo-location module 270 would then determine whether any merchants were within a defined radius of the member's geo-location. As will be appreciated, the geo-location module 270 could be set, including by reference to program participant preferences, to update, compare and make such determination at various times, with reference to program participant movement (e.g., over a certain distance or with reference to other program participants).

Once the enterprise system 105 determines whether there are other program participants within the vicinity of the program participant, the enterprise system 105 can logically “link” the program participant with other program participants in the same geographical area. Thus, if a member is located in Los Angeles, the member can be logically linked to merchants in Los Angeles while the member moves through the Los Angeles area. During its movements through Los Angeles, the member might be linked (and unlinked) to program participants and geographic sub-divisions of various sizes and natures and/or the like as defined by the program provider. For example, where geographical barriers such as mountains, bays or rivers might prevent transport communication between two areas otherwise within the defined parameter, the geo-location module 270 might de-link program participants otherwise within the parameter. As will be appreciated, the geo-location module 270 could be set to make these linkage (and de-linkage) determinations.

As indicated in Blocks 635 to 650, after program-participant linkage determinations have been made, the enterprise system 105 may transmit an electronic message to program participant's mobile 100. The term “electronic message” in this context is used generically to refer to a list of program participants linked to, for example, merchants within a defined geographic radius of a member's geographic location. In addition to a list of program participants linked to a particular program participant such as a member, the electronic message may also include the street address, a description, a map representation and routing information for such program participants provided by the geo-location module 270 for each program participant.

Information contained within the electronic message may be used by program participants to determine their movements with respect to the geo-location of other program participants after a mobile 100 receives and displays at least a portion of the electronic message as shown in Blocks 655 to 665. For example, a member may use information from the electronic message displayed on a mobile electronic device 100 held by the member after log-in to determine the street addresses of nearby merchants participating in a program.

In one embodiment, for the mobile 100 to receive the electronic message, the electronic message may first be sent to various other computing devices. In transmitting the electronic message, in one embodiment, the enterprise system 105 may transmit it using two separate files. For example, according to one embodiment, the electronic message can be sent using a first message file and a second message file. The first message may include information relating to program participants located within a defined geographic area. The second message file may contain include information (or at least a portion) relating to description and routing instructions. As will be recognized, the message files are illustrative and are not limiting to the various embodiments described herein. Thus, in another contemplated embodiment, the electronic message may be a single message file or multiple message files, which are transmitted to various computing devices.

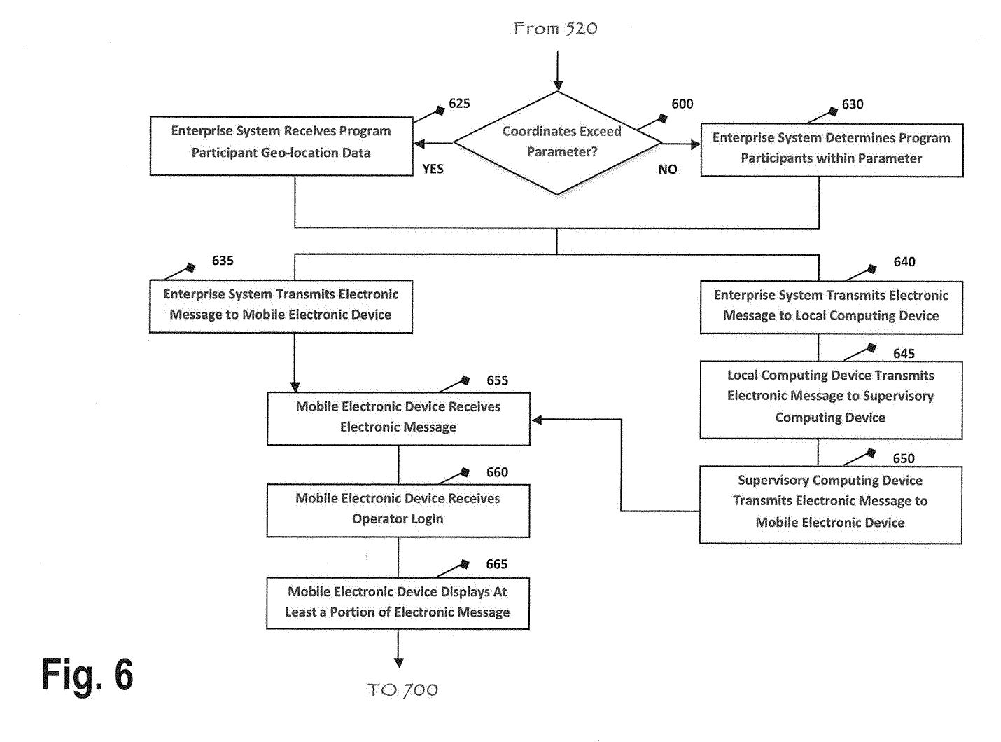

As show in FIG. 6 and indicated above, the electronic message may first be sent to and received by various other computing devices before being sent to and received by the mobile electronic device 100. For example, as show in Block 640, the enterprise system may transmit the electronic message to a local computing device 110 (Block 640), the local computing device 110 may then transmit the electronic message to the supervisory computing device (Block 645), the supervisory computing device may then transmit the electronic message to the mobile 100 (Block 650). In these contemplated embodiments, transmitting the electronic message to the various computing devices may serve different functions.

With respect to the local computing device 110, in one embodiment, the local computing device may function as a gateway or central location to receive information for a region, a general area, or hub. For example, for all program participant program activity taking place in or through the greater Atlanta area, a single location could serve as the central communications point for all program participants within the Atlanta area. In another embodiment, the local computing device 110 could serve a managerial function for a region, such as assigning the various electronic messages to the supervisory computing devices 115. This architecture may facilitate network redundancy or managerial functions, including monitoring the flow of electronic messages within the region.

With respect to the supervisory computing device 115, in one embodiment, the supervisory computing device 115 may be used to coordinate various functions within a region. For example, in one embodiment, the supervisory computing device 115 may be located in a geographical location near a concentration of program participants. In this embodiment, the supervisory computing device 115 may assign or dispatch electronic messages to program participants in the location. As will be recognized, in the contemplated embodiments, there may be multiple supervisory computing devices 115 in an area. For example, there may be five supervisory computing devices 115 in an area used by program provider personnel to coordinate the flow of electronic messages in the area.

During the entire process of transmitting electronic messages to program participants in a program, the program provider and certain program participants may have access to real-time current status information regarding program participant movements and electronic messages transmitted to such participants. The term “current status information” is used generically to refer to data about the program participant, program participant geo-location, program participant movements and electronic messages transmitted to such program participants and/or the like. In one embodiment, as the current status information is received by the supervisory computing device 115, the supervisory computing device 115 may transmit this information to the local computing device 110 and/or the enterprise system 105 (e.g., via the visibility module 250) and/or the supervisory computing device 115 (e.g., via the visibility module 250) may periodically poll mobiles 100 for current status information. With current status information, the enterprise system 105 and/or the supervisory computing device 115, via their respective visibility modules, can provide real-time current status information to the various entities (Block 700). For example, a program provider manager can monitor the status of program participant locations, movements and electronic messages transmitted to such program participants in an area. This functionality provides real-time visibility for program participant activity in an area.

In addition to providing real-time status information, the enterprise system 105 may generate a variety of reports (Block 705) with data it receives or with data received by mobiles 100. Information in the reports may include program participant numbers, movement patterns, electronic message receipt and/or the like. As will be recognized, though, there are a variety of reports that can be generated with the information received and/or generated by the enterprise system 105, the local computing device 110 and the supervisory computing device 115.

### B. Program Affiliate Marketing

A system according to a particular embodiment may include the mobile electronic device 100, the enterprise system 105, the local computing device 110 and a supervisory computing device 115 to provide for sign-up of program participants by affiliates and attribution of program participant program activity to affiliates for commission payment purposes. For example, the enterprise system 105 may provide a link or links enabling an affiliate to engage in affiliate marketing for a program provider, whereby the affiliate may market a program to potential program participants. For example, a unique identifier (e.g., an electronic message identifying a person who clicks through a program link on a remote computing device such as a mobile 100 to become an affiliate) referred to generically herein as an “affiliate identification” may be assigned to an affiliate by the enterprise system 105 for example when an affiliate applies to be a program affiliate. Alternatively the enterprise system 105 may associate a unique identifier such as attached to a web beacon or cookie as the unique identifier for the affiliate. The enterprise system 105 may then associate the affiliate identification to a unique identifier for a person that clicks through a link on an affiliate advertisement to register on the enterprise system 105 to become a member or merchant, the unique identifier for such person which may be referred to generically herein as a “program participant identification” and, together with the affiliate identification as a “program participant affiliate identification.” The enterprise system 105 may then reward the affiliate, perhaps after the program participant has been qualified in some manner by the enterprise system 105. As will be appreciated by one skilled in the art, there may be several ways to identify affiliates and program participants, including such methods as self-identification, assignment of a program-assigned code, cookies, web-beacons or combinations of such methods.

As will be appreciated, the term “affiliate” as used generically here, may have reference to marketing intermediaries who refer third parties to a business for a performance-based commission, via the web (such as via blogs, informational websites, referral videos, links) or other means such as standalone software, hosted services, shopping carts and third party affiliate networks. “Program affiliate link” as used generically herein may have reference to a web-link generated by a program for an affiliate wishing to be a program affiliate, which the affiliate may place in web-based promotional material, which when clicked through to a program registration web screen, creates program participant affiliate identification associating the person clicking through the link with the affiliate and enabling ongoing tracking “Affiliate marketing” as used generically here may have reference to a marketing practice in which a business rewards one or more affiliates for each visitor or customer brought by the affiliate's marketing efforts and/or for activities engaged in by such visitors or customers, for example by the payment of a commission for every member or merchant that registered in a program that purchases or sells products or services through such program. The term “affiliate data” as used generically herein may have reference to the affiliate identification and other information relating to an affiliate. The term “program participant affiliate data” as used generically herein may have reference to the program participant affiliate identification and other information relating to a program participant and an affiliate. The terms “attribute” or “attribution” as used generically herein may have reference to the ascribing, imputing or assigning of program activity as due to the sales or marketing efforts of another such as an affiliate. The term “attribution data” as used generically herein may have reference to information or data relating to attribution. The terms “qualify”, “qualifying” or “qualification” as used generically herein may have reference to a process of determining whether program activity meets program requirements for inclusion in affiliate commission calculation. The term “qualification data” as used generically herein may have reference to information or data relating to program activity determined by the enterprise system 105 to be qualified for commission.

The enterprise system 105 can use the information provided by a remote computing device such as the mobile 100 to associate program participant registration with affiliate efforts to promote a program. For example, a person clicking through a program link on a mobile 100 can be attributed to an individual affiliate. This enables the enterprise system 105 to track the person's registration as a program participant and other activities then reward the affiliate for the affiliate's marketing efforts to attract program participant registration. For example, the program system 105 can enable payment of a commission to the affiliate upon sign-up of an individual member or merchant, perhaps after additional qualifying activities by such program participant, such as viewing advertisements or purchasing products or services.

As will be appreciated, other activities can also be attributed for commission purposes. For example, the enterprise system 105 can use a remote computing device such as the mobile 100 to associate the affiliate and the program participant with program activity. For example, after the program participant affiliate identification is determined, the mobile 100 may associate the program participant affiliate identification with electronic identifiers or metadata tags relating to program activity by program participants such as purchases, web movement or responses to advertising, which may be together referred to generically herein whether associated by a remote computing device such as a mobile 100 or an enterprise system 105 as “program participant affiliate activity data” and transmit such data to the enterprise system 105. The enterprise system 105 may generate an electronic message, which may include the program participant's geo-location coordinates, information about such program participants and the activities of such program participants.

In the tracking process, according to one embodiment, the mobile electronic device 100 may track the member's movements and send data on the member's movements to the enterprise system 105. As updated information is received, the enterprise system 105 can send updated electronic messages such as above described. During the entire affiliate marketing process, the enterprise system 100 may also receive data about program activity, for example program participants signed up in a program due to affiliate marketing activities, member's purchases with merchants, program participant movements by geo-location, attribute such program activity to affiliates, calculate and pay commissions to affiliates for program activity attributed to affiliates, and/or the like. The term “affiliate commission data” as used generically herein may have reference to commission paid to an affiliate and program activity information relating to such commission. The mobile electronic device 100 may even provide the above-described information to the enterprise system 105 and/or the local computing device 110 and/or the supervisory computing device 115 as it is received. This information can then be used to generate reports and provide real-time visibility of the information to the program provider and/or other program participants.

Reference will now be made to FIGS. 8-10, which provide an example of operations and input and output produced by various embodiments of the present invention. In particular, FIG. 8 provides a flowchart illustrating operations that may be performed to support affiliate marketing in a program by enabling affiliate attribution and compensation for qualified program participant sign-up and activity. The terms “affiliate” or “program affiliate” may be used used generically herein to refer to an affiliate that has registered to market a program as an affiliate.

Before the process begins, in one embodiment, the affiliate may be enabled by the enterprise system 105 to register to be a program affiliate on or via a remote computing device (Block 800). This may be accomplished on a mobile 100 or other remote computing device. Alternatively, the affiliate may register directly on the enterprise system 105. At this time, the enterprise system 105 or alternatively the remote computing device such as the mobile 100 may generate an affiliate identification (Block 805). The affiliate identification may be received before, during, or after turning on program functionality available through a program application on a remote computing device such as a mobile 100, pursuant to which an affiliate accessing a remote computing device such as a mobile 100 may log-in to the remote computing device and register as a program affiliate. Alternatively, a program application could automatically cause the remote computing device to transmit the affiliate's affiliate identification to the enterprise system 105 when the affiliate registers on a website on the enterprise system 105 (not illustrated).

After the remote computing device generates the affiliate identification, the remote computing device generates a program link and transmits the affiliate identification to the enterprise system where the affiliate identification is stored (Blocks 810-825). As will be appreciated, the program link may enable the remote computing device to replicate the program link for such program link to be placed in affiliate electronic marketing materials. Alternatively the enterprise system 105 may perform these functions in the place of the remote computing device. After the remote computing device or enterprise system 105 generates a program affiliate link, the affiliate may post the program affiliate link in a website, blog, email or other promotional material to promote the program (Block 825). When a party clicks through the program affiliate link, the enterprise system 105 records the visit of such party to the program website accessed via the program link (Block 900).

After the enterprise system 105 records the visit of the party, the enterprise system 105 determines whether such party has already been associated with an affiliate or commission already paid to the affiliate (Blocks 905-910). This may be accomplished by comparing the unique identifier of the party with the unique identifiers of other parties recorded in the enterprise system 105. If there is a match, the enterprise system 105 may update information on the party and the affiliate (Block 920). If there is no match, the enterprise system 105 generates and stores a program participant affiliate identification and generates and stores program participant program activity data when the program participant registers as a program participant and engages in program activities (Block 925-945). The enterprise system then determines affiliate's entitlement to commission depending on program requirements (Block 950). For example, a program may establish that an affiliate is entitled to commission for each member that registers after clicking through a program affiliate link associated with the affiliate. Alternatively, commission entitlement could be tied to other program activities such as purchases of goods or services or clicking on program links to program participants or advertisements on a program website.

After the enterprise system 105 determines whether an affiliate is entitled to commission (Block 1000), the enterprise system 105 may determine the amount of such commission, then store, transmit (pay) the commission to the affiliate and update information in the enterprise system 105 on the commission (Block 1010-1020). The enterprise system 105 may then transmit an electronic message to a local remote computing device and a supervisory computing device 115 which may then transmit a message to the program participant's mobile 100 and display current status information and generate reports on commissions paid.

At each point where affiliate data is created, the enterprise system 105 can receive the affiliate data and may determine the current status of affiliated program participants and commissions due and paid to affiliates. As indicated in Blocks 1000 to 1025, after commission entitlement determinations have been made a, the enterprise system 105 may transmit an electronic message to a remote computing device or even affiliate's mobile 100. In this context, the term “electronic message” may be used generically to refer to a list of program participants linked to the affiliate and the relevant program activities of such program participants entitling the affiliate to commission. Information contained within the electronic message may be used by affiliates to determine the effectiveness of their promotional efforts after a remote computing device receives and displays at least a portion of the electronic message as shown in Blocks 1035 to 1040. For example, a member may use information from the electronic message displayed on a mobile electronic device 100 held by the member after log-in to determine how many program participants have responded to the affiliate's electronic promotional materials to register in a program and participate in program activity.

In one embodiment, for the mobile 100 to receive the electronic message, the electronic message may first be sent to various other computing devices. In transmitting the electronic message, in one embodiment, the enterprise system 105 may transmit it using two separate files. For example, according to one embodiment, the electronic message can be sent using a first message file and a second message file. The first message may include information relating to program participants registration. The second message file may contain or include information (or at least a portion) relating to commission. As will be recognized, the message files are illustrative and are not limiting to the various embodiments described herein. Thus, in another contemplated embodiment, the electronic message may be a single message file or multiple message files, which are transmitted to various computing devices.

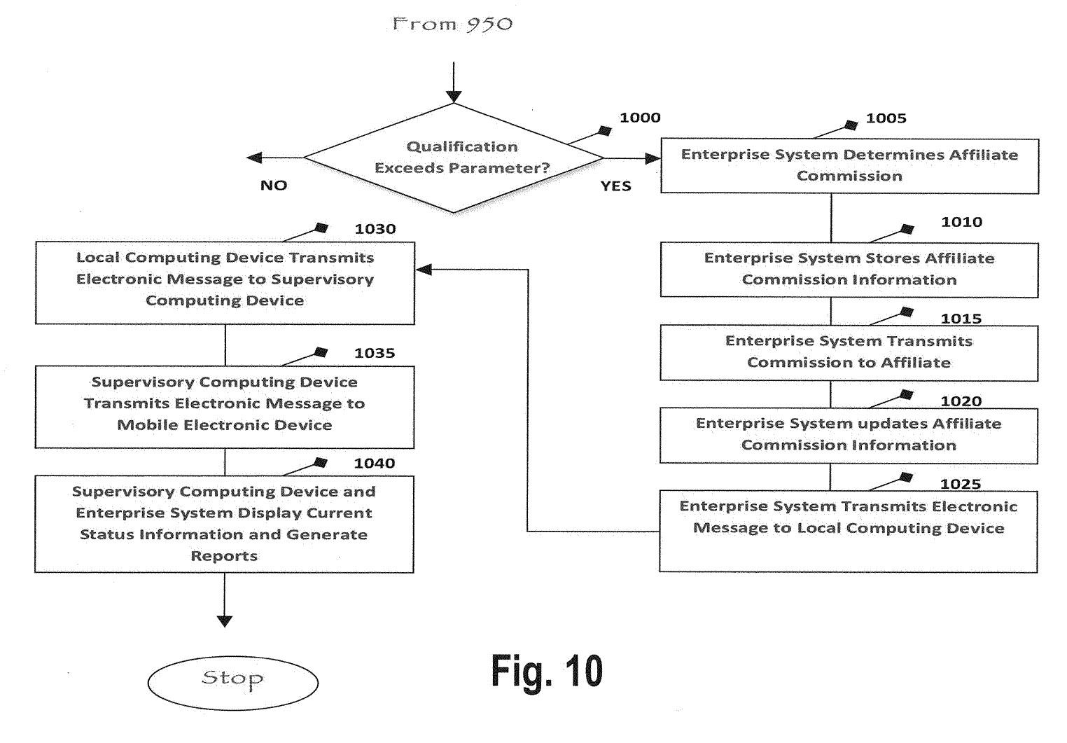

As show in FIG. 10 and indicated above, the electronic message may first be sent to and received by various other computing devices before being sent to and received by the mobile electronic device 100. For example, as show in Block 1025, the enterprise system may transmit the electronic message to a local computing device 110 (Block 1025), the local computing device 110 may then transmit the electronic message to the supervisory computing device (Block 1030), the supervisory computing device may then transmit the electronic message to the mobile 100 (Block 1035). In these contemplated embodiments, transmitting the electronic message to the various computing devices may serve different functions.

With respect to the local computing device 110, in one embodiment, the local computing device may function as a gateway or central location to receive information for a region, a general area, or hub. For example, for all program participant activity taking place in or through the greater Atlanta area, a single location could serve as the central communications point for all program participants within the Atlanta area. In another embodiment, the local computing device 110 could serve a managerial function for a region, such as assigning the various electronic messages to the supervisory computing devices 115. This architecture may facilitate network redundancy or managerial functions, including monitoring the flow of electronic messages within the region.

With respect to the supervisory computing device 115, in one embodiment, the supervisory computing device 115 may be used to coordinate various functions within a region. For example, in one embodiment, the supervisory computing device 115 may be located in a geographical location near a concentration of program participants. In this embodiment, the supervisory computing device 115 may assign or dispatch electronic messages to program participants in the location. As will be recognized, in the contemplated embodiments, there may be multiple supervisory computing devices 115 in an area. For example, there may be five supervisory computing devices 115 in an area used by program provider personnel to coordinate the flow of electronic messages in the area.

During the entire process of transmitting electronic messages to affiliates involved in promoting a program, the program provider and certain program participants and affiliates may have access to real-time current status information regarding program participant activities and electronic messages transmitted to such participants. The term “current status information” is used generically to refer to data about the affiliate, program participants registering and engaging in programs due to affiliates and electronic messages transmitted to such affiliates and/or the like. In one embodiment, as the current status information is received by the supervisory computing device 115, the supervisory computing device 115 may transmit this information to the local computing device 110 and/or the enterprise system 105 (e.g., via the visibility module 250) and/or the supervisory computing device 115 (e.g., via the visibility module 250) may periodically poll the enterprise system 105 for current status information. With current status information, the enterprise system 105 and/or the supervisory computing device 115, via their respective visibility modules, can provide real-time current status information to the various entities (Block 1040). For example, a program provider manager can monitor the status of affiliates, program participant registrations and program activity after sign-up and electronic messages transmitted to such affiliates in an area. This functionality provides real-time visibility for affiliate and program participant activity.

In addition to providing real-time status information, the enterprise system 105 may generate a variety of reports (Block 1040) with data it receives. Information in the reports may include program participant numbers, program activities entitling affiliates to commission and/or the like. As will be recognized, though, there are a variety of reports that can be generated with the information received and/or generated by the enterprise system 105, the local computing device 110 and the supervisory computing device 115.

### C. Program Targeted Advertising

A system according to a particular embodiment may include the mobile electronic device 100, the enterprise system 105, the local computing device 110 and a supervisory computing device 115 to provide for program targeted advertising. For example, the enterprise system 105 may track and store program activity and other information in an enterprise system 105 database. The enterprise system 105 may use such information to determine the advertising relevance of available advertising, then select, deliver and track the effectiveness of such advertising for program participants. Alternatively the enterprise system 105 may constantly update the program profile of a program participant with program participant data or external data and use summary metadata from such profile to determine advertising relevance or even proactively solicit relevant advertising from advertisers. The term “program profile” may be referred to generically herein to refer to the profile of a program participant created with member data such as address, zip code, name, address or gender when a program participant registers in a program or updates such profile. The term “program profile data” may be used generically herein to refer to data contained within a program profile. The term “program participant advertising relevance profile” may be used generically herein to refer to a program participant's program profile together with program activity or external data relating to the program participant, with or without the use of descriptive metadata. The term “program participant advertising relevance profile data” may be used generically herein to refer to data or metadata contained within a program participant advertising relevance profile.

As will be appreciated, the terms “targeted advertising” or “relevant advertising” as used generically herein, may have reference to a method of advertising whereby advertisements are placed based on demographic, purchase history or observed behavioral traits. The terms may also have reference to the placing of advertisements based on such criteria as web pages viewed. As will be appreciated by one skilled in the art, there may be several ways to determine advertising relevance, including such methods as observing purchasing history, web-browsing behavior of program participants such as web pages visited or searches made in context, geography, demographics of program participants, the application of off-site and on-site web analytics such as page tagging, logfile analysis or click analytics to information thus collected, the application of predictive logarithms to information thus collected or combinations of such methods. The term “program targeted advertising” as used generically herein may have reference to systems, methods and computer products relating to targeted advertising in programs. The term “advertising relevance” as used generically herein may have reference to a determination that an advertisement is pertinent, connected or applicable to a potential target such as a program participant.

The enterprise system 105 can use program participant data, external data and information contained within a program profile or program participant advertising relevance profile to determine the relevance of an advertisement to a program participant. For example, a program participant may be selected for exposure to an advertisement because the advertisement is targeted to program participants of a certain demographic in a particular geography. In order to make the advertising relevance determination the enterprise system 105 may have reference to advertising metadata and program participant data and profiles stored in the enterprise system 105, which can be updated continuously, for example when a program participant logs in, logs out or when prompted by the enterprise system 105. For example, as a program participant travels and shops, the enterprise system 105 may track program activity data and geo-location data which may then also become part of the program participant's advertising relevance profile that can be used to refine advertisement selection criteria, even in real time. The enterprise system 105 may query program participant data or program participant advertising relevance profiles for advertising relevance for available advertising, for example when a program participant logs onto the system or as new advertisements become available. The enterprise system 105 may also market anonymized program participant advertising relevance profile data to solicit bids from advertisers willing to pay at various levels to have their advertisements provided or exposed to program participants depending on advertising relevance. The enterprise system 105 can then select the advertisements determined to be relevant and deliver such advertisements to the program participant. Advertisement delivery can take place via any means, such as via the program participant's mobile 100, a remote computing device or any means associated with the program participant, such as cable television, video on demand or email. The enterprise system 105 can then track a program participant's program activity following the program participant's exposure to an advertisement. This enables the enterprise system 105 to constantly assess and report advertising effectiveness and further update the program participant's advertising relevance profile to enable ever more refined targeted advertising.

The enterprise system 105 can use a remote computing device such as the mobile 100 to determine program participant availability, to update and query program participant advertising relevance profiles and associate the program participant with program activity. For example, after the program participant affiliate identification is determined upon login, the mobile 100 may associate the program participant affiliate identification with identifiers relating to program activity by program participants such as purchases, web movement or responses to advertising and transmit such data to the enterprise system 105. The enterprise system 105 may generate an electronic message, which may include the program participant's geo-location coordinates, information about such program participants, the activities of such program participants and advertisements determined to be relevant to such program participants.

Reference will now be made to FIGS. 11-12, which provide an example of operations and input and output produced by various embodiments of the present invention. In particular, FIG. 11 provides a flowchart illustrating operations that may be performed to support targeted advertising in a program.

Before the process begins, in one embodiment, the enterprise system 105 receives registration information for a program participant (Block 1100). This may be accomplished on a mobile 100 or other remote computing device. Alternatively, the program participant may register directly on the enterprise system 105. At this time, the enterprise system 105 or alternatively the remote computing device such as the mobile 100 may generate a program participant advertising relevance profile (Block 1105). The program participant advertising relevance profile may be created before, during, or after turning on program functionality available through a program application on a remote computing device such as a mobile 100, pursuant to which a program participant accessing a remote computing device such as a mobile 100 may log-in to the remote computing device and register as a program affiliate.

After the enterprise system 105 generates the program participant advertising relevance profile, the enterprise system 105 may track and store the program participant's program activity data, combine such data with additional or external third party data if desired, such as psychographic data on lifestyle, attitudes, beliefs, values, buying motives or extent of product usage of the program participant or data from other sources and update the program participant advertising relevance profile (Blocks 1110-1125). As will be appreciated, the enterprise system 105 may periodically update the program participant advertising relevance profile, upon the occurrence of certain actions such as log-in or log-out or continuously when program activity occurs. As will additionally be appreciated, the enterprise system 105 may enable the remote computing device to perform any or all of these functions. Alternatively the enterprise system 105 may perform these functions in the place of the remote computing device. Additionally, the enterprise system 105 on the basis of the program participant advertising relevance profile may, perhaps on the basis of program participant consent or using anonymized data, proactively market program participant relevant advertising profiles to advertisers willing to pay to have their advertisements exposed or delivered to program participants depending on advertising relevance. The enterprise system 105 may even auction program participant profiles to potential advertisers and present advertisements from advertisers willing to pay the highest price for advertising targeted to particular profiles.

Simultaneously with, preceding or following the aforementioned activities, the enterprise system 105 may receive advertising metadata, a term that may be used generically herein to refer to data used to describe electronically archived or presented advertisements, such as a description of the demographic and geography of persons for whom an advertisement is intended, and which may be comprised of metadata tags, which is a term that may be used generically herein to refer to a kind of electronic keyword or bookmark describing something such as an advertisement or program participant (Block 1200). As will be appreciated, receipt of such data may accompany or precede receipt of the advertisements themselves, whether in digital or other format, which may be delivered to or retrieved by the enterprise system 105 simultaneously with receiving the advertising metadata relating to such advertisement or at a later time.

After receiving the advertising metadata, at any time, the enterprise system 105 may index the data (not pictured) and determine advertising relevance for the related advertisements by determining which program participants match the advertising metadata (Blocks 1205-1210). The enterprise system 105 may accomplish this by querying the program activity data for program participants and determining which program participant data matches the metadata tags for subject advertisements. Alternatively, the enterprise system 105 may query program participant advertising relevance profiles of logged-in program participants and determine whether the metadata tags for such program participants match the metadata tags of subject advertisements. As will be appreciated, the enterprise system 105 may use various criteria to determine which program participants on which to run queries. For example, the enterprise system 105 might only run queries for logged-in program participants, at the time a program participant logs-in or on the basis of pre-determined program activity such as purchase of a particular product or service or visiting a particular web page. If there is no match, the enterprise system 105 may record such fact in data relating to the advertisement (Block 1215) and use such data to determine the effectiveness of the advertisement for program participants (Block 1265). If there is more than one match, or for example if the program is enabling advertisers to bid to submit advertising to program participants, the enterprise system 105 may determine the priority of available relevant advertisements for the program participants by ranking the available advertisements, for example according to which advertisements have the most advertising metadata matches and/or by a weighting mechanism determining which advertisement exposures will generate the highest return. The enterprise system 105 may also make this determination by reference to program activity being tracked at the time, whereby the enterprise system 105 selects the highest priority advertisement according to the type of program activity taking place at the time. For example, if a member enters an online sporting goods store and has recently purchased a soccer ball, the enterprise system 105 might give a higher priority to advertisements for soccer cleats and hold lower priority advertisements in reserve. For a merchant selling sporting goods, the enterprise system 105 might give a higher priority to advertisements from wholesalers of related product lines. As an additional example, if a member is within two miles of several merchants, the enterprise system 105 might give a higher priority to advertisements from merchants in the area who wish to advertise on member mobile devices they are giving 10% “rewards” for member purchases.

At this point, the enterprise system 105 may retrieve the best matching advertisement, deliver it to the program participant and continue monitoring the program participant's program activity (Blocks 1220-1250). As will be appreciated, advertisements may be retrieved from enterprise system 105 databases or external sources. As will further be appreciated, there are many potential methods for advertising delivery. For example, the enterprise system 105 may deliver advertising to a member's mobile 100, another remote computing device, to a program participant's email or even via insertion to the advertising stream applicable to the program participant via television, satellite or video-on-demand. Advertising retrieval and delivery may take place in real time to correspond with program activity or at any time.

After the enterprise system 105 delivers matching advertising to the program participant (Block 1250), the enterprise system 105 may track the program participant's response to the advertisement (Block 1255). For example, the enterprise system 105 may track web-page views, click-throughs and product purchases for a defined period of time. Then, the enterprise system 105 may determine the effectiveness of advertisements presented, for example whether a purchase was made, report the results and update the program participant's advertising relevance profile based on advertising responses and non-responses (Blocks 1260-1265).

At each point, the enterprise system 105 may transmit an electronic message to a local remote computing device and a supervisory computing device 115 which may then transmit a message to a remote computing device. Data generated throughout this process relating to advertisements may be referred to generically herein as “advertising data.” At each point where advertising data is created, the enterprise system 105 may transmit an electronic message to a remote computing device. In this context, the term “electronic message” may be used generically to refer to any message containing advertising data. Information contained within the electronic message may be used to determine the effectiveness of advertisements not exposed or exposed after a remote computing device receives and displays at least a portion of the electronic message as shown in Blocks 1215 and 1260 or Blocks 1250 to 1260 respectively. For example, a program provider may use information from the electronic message displayed on a supervisory computing device 125 to determine which advertisements have received the most exposures for which program participant advertising relevance profiles.

In one embodiment, for a remote computing device to receive the electronic message, the electronic message may first be sent to various other computing devices. In transmitting the electronic message, in one embodiment, the enterprise system 105 may transmit it using two separate files. For example, according to one embodiment, the electronic message can be sent using a first message file and a second message file. The first message may include information relating to program participants registration. The second message file may contain or include information (or at least a portion) relating to advertising data. As will be recognized, the message files are illustrative and are not limiting to the various embodiments described herein. Thus, in another contemplated embodiment, the electronic message may be a single message file or multiple message files, which are transmitted to various computing devices.

With respect to the local computing device 110, in one embodiment, the local computing device may function as a gateway or central location to receive information for a region, a general area, or hub. For example, for all program participant activity taking place in or through the Rochester, N.Y. area, a single location could serve as the central communications point for all program participants within Rochester. In another embodiment, the local computing device 110 could serve a managerial function for a region, such as assigning the various electronic messages to the supervisory computing devices 115. This architecture may facilitate network redundancy or managerial functions, including monitoring the flow of electronic messages within the region.

With respect to the supervisory computing device 115, in one embodiment, the supervisory computing device 115 may be used to coordinate various functions within a region. For example, in one embodiment, the supervisory computing device 115 may be located in a geographical location near a concentration of program participants or advertisers delivering advertisements. In this embodiment, the supervisory computing device 115 may assign or dispatch electronic messages to program participants in the location. As will be recognized, in the contemplated embodiments, there may be multiple supervisory computing devices 115 in an area. For example, there may be five supervisory computing devices 115 in an area used by program provider personnel to coordinate the flow of electronic messages in the area.

During the entire process of transmitting electronic messages containing advertising data, the program provider and certain program participants may have access to real-time current status information regarding program participant activities and advertisements transmitted to program participants. In this context, the term “current status information” is used generically to refer to data about advertisement exposures, advertising weighting, advertisement priority, advertising response, and/or the like. In one embodiment, as the current status information is received by the supervisory computing device 115, the supervisory computing device 115 may transmit this information to the local computing device 110 and/or the enterprise system 105 (e.g., via the visibility module 250) and/or the supervisory computing device 115 (e.g., via the visibility module 250) may periodically poll the enterprise system 105 for current status information. With current status information, the enterprise system 105 and/or the supervisory computing device 115, via their respective visibility modules, can provide real-time current status information to the various entities. For example, a program provider manager can monitor the status of advertisers, program participant responses to advertisements and program activity. This functionality provides real-time visibility for program targeted advertising and program participant activity.

In addition to providing real-time status information, the enterprise system 105 may generate a variety of reports and documents such as invoices (not illustrated) with data it receives. Information in the reports may include advertisements, numbers of advertising exposures, program participant responses, profile data from program participants that responded, commissions generated for advertisements delivered and/or the like. As will be recognized, though, there are a variety of reports and documents that can be generated with the information received and/or generated by the enterprise system 105, the local computing device 110 and the supervisory computing device 115.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for tracking the geo-location of program participants for correlation with the geo-location of other program participants, the method comprising:
receiving, via an enterprise system, data associated with a program participant, wherein the data comprises a unique identifier assigned to the program participant and information corresponding to the program participant's geo-location;
generating, via the enterprise system, an electronic message, wherein the electronic message comprises at least a portion of (a) the program participant's program participant geo-location data, and (b) the program participant's program participant data contained within the system corresponding to the geo-location of nearby program participants, (c) program participant data of other program participants corresponding with the geo-location of the program participant; and (d) advertising for program participants enabled for delivery via the enterprise system;
electronically transmitting, from the enterprise system to a remote computing device for display, an electronic message that comprises at least a portion of the program participant's geo-location data and program participant data and advertising enabled for delivery via the program system; and
receiving, via the enterprise system, transmitted from the remote computing device, an initiation of a location event for the program participant, wherein the location event indicates (a) the geo-location of the program participant and (b) an electronic message containing at least a portion of information displayed on the remote computing device.

2. The method of claim 1, further comprising causing display, via a supervisory computing device, of current status information indicating the program participant's geo-location, movement, geographic position and geographic position of other program participants.

3. The method of claim 1 further comprising:
receiving, via a remote computing device, the program participant data and program participant geo-location data corresponding with the program participant; and
electronically transmitting, from the enterprise system to the remote computing device, at least a portion of the program participant data and program participant geo-location data.

4. The method of claim 1, wherein the electronic message is transmitted using a first message file, the first message file comprising program participant geo-location data and the second message file comprising at least a portion of the program participant data.

5. The method of claim 1, wherein the location event further indicates that the program participant is moving from a first location to a second location.

6. The method of claim 5 further comprising receiving information identifying the second location of the program participant.

7. The method of claim 5, wherein the information identifying the second location is received as input from a program participant.

8. The method of claim 5, wherein the information identifying the second location is received from a program participant that processed a transaction for a program participant such as a member.

9. The method of claim 4, wherein the program participant information transmitted to the program participant corresponds with the program participant's second location.

10. The method of claim 1, wherein the data received by the enterprise system is an electronic message defining a geographic area for which the program participant wishes to receive program participant data (a) transmitted by a program participant from a remote computing device to an enterprise system in response to a remote computing device or (b) directly initiated by a program participant with an enterprise system.

11. The method of claim 1, wherein the electronic message is transmitted from a remote computing device to another remote computing device.

12. A computer program product for enabling a remote computing device to generate, transmit to an enterprise system and receive from the enterprise system program participant geo-location data, the computer program product comprising at least one computer-readable storage medium having computer-readable program code portions stored therein, the computer-readable program code portions comprising:
an executable portion configured to generate an application for delivery to a remote computing device when a program participant executes a request to receive an application in response to a remote computing device;
an executable portion configured to transmit an application from an enterprise system to a remote computing device when a program participant executes a request in response to a remote computing device;

13. The computer program product of claim 12, further comprising an executable portion configured to generate an application for delivery to a remote computing device where the program participant initiates the request directly with the enterprise system not in response to a remote computing device.

14. The computer program product of claim 12 further comprising an executable portion configured to receive a message automatically transmitted from a remote computing device in response to execution of the application delivered from the enterprise system to the remote computing device.

15. The computer program product of claim 12 further comprising (1) an executable portion configured to transmit a message from the enterprise system to the remote computing device in response to a message received from the remote computing device, (2) an executable portion configured to receive a second message automatically transmitted from a remote computing device in response to execution of the application delivered form the enterprise system to the remote computing device and, (3) an executable portion configured to transmit a second message from the enterprise system to the remote computing device in response to a second message from the remote computing device.

16. The computer program product of claim 12 further comprising (1) an executable portion configured to store data received by the enterprise system from the remote computing device and data transmitted from the enterprise system to the remote computing device and, (2) and an executable portion configured to retrieve and organize data received and transmitted for reporting and presentation purposes.

17. A computer program product enabling receipt by an enterprise system of program participant geo-location data generated by a remote computing device, the computer program product comprising at least one computer-readable storage medium having computer-readable program code portions stored therein, the computer-readable program code portions comprising:
an executable portion configured to receive a first message transmitted from a remote computing device when a command is executed or when a predefined threshold is met;
an executable portion configured to receive a message automatically transmitted when a program participant effects a request after the remote computing device (a) causes display of an advertisement, (b) provides access to a website, (c) effects purchase from a program participant, (d) determines that a predefined threshold is met, (e) enables a program participant to enter geo-location information into the remote computing device, or (f) effects a log-in protocol; and
an executable portion configured to receive a message automatically transmitted when a program participant effects a request that (a) causes display of an advertisement, (b) provides access to a website, (c) effects purchase from a program participant, (d) effects a sale to a program participant, (e) enters geo-location information into the remote computing device, or (f) effects a log-in protocol.

18. The computer program product of claim 18 further comprising an executable portion configured to receive a second message transmitted from a remote computing device when (a) a request is effected, (b) in response to an electronic message sent from an enterprise system triggering execution of an executable protocol in the remote computing device, (c) in response to an electronic message sent from an enterprise system containing an executable command, or (d) when a predefined threshold is met.

19. The computer program product of claim 18 further comprising an executable portion configured to transmit a first message from an enterprise system to a remote computing device when the enterprise system receives a first electronic message from the remote computing device.

20. The computer program product of claim 18 further comprising an executable portion configured to transmit a second message from an enterprise system to a remote computing device when the enterprise system receives a second electronic message from the remote computing device.
